(19) United States
(12) Patent Application Publication
(10) Pub. No.: US 2015/0332405 A1
(43) Pub. Date: Nov. 19, 2015

(54) SYSTEM AND METHOD FOR EVALUATING AN IDEA WITH EXPERT REVIEW OVER A COLLABORATIVE PLATFORM

(71) Applicant: Healthcare Innovation and Technology Lab, Inc., New York, NY (US)

(72) Inventors: Stan W. Kachnowski, Tarrytown, NY (US); Cole R. Manship, New York, NY (US); Ashish Jha, New Delhi (IN); R. Keerthi Prasad, Delft (NL)

(21) Appl. No.: 14/713,860

(22) Filed: May 15, 2015

Related U.S. Application Data
(60) Provisional application No. 61/993,409, filed on May 15, 2014.

(51) Int. Cl. G06Q 40/06; G06F 17/30

(52) U.S. Cl. CPC G06Q 40/06; G06F 17/30675

(57) ABSTRACT

A system and method for providing unbiased, expert panel to review a requested idea is disclosed. This invention relates to a computerized, online system that facilitates the review of an idea for investment chosen by an investor. The expert panel is either selected by the investor, automatically suggested, or recommended through the administrator system based on internal data corresponding to the experts. Experts are selected based on ability to provide the most relevant scoring and fitting analysis of the chosen idea. The investor is able to assign a percentage weight not only to the experts, but upon the criteria factors of analysis as well to eliminate any potential bias of one particular expert. The experts analyze the innovation or idea based on pertinent criteria in this field and subsequently recommend a monetary value or equity exchange suitable for investing in the particular idea.

### BACKGROUND OF THE DISCLOSURE

The world of open innovation platforms and impact investing has rapidly become a prolific area through advancements in communications technology and societal awareness of global problems. Entrepreneurs with ideas ripe for investment want the ability to easily and readily promote their ideas to investors. Investors want the ability to more easily to access innovators, to invest in ideas that have the potential to solve global problems. However, with the ubiquity and fast-paced launch of innovations, investors are often faced with the problem of evaluating the success or capability of an idea without having precise expertise in the particular area of innovation. Furthermore, finding an unbiased, third party opinion can be a costly and time-consuming venture, eliminating crucial resources and likelihood of an investor to invest.

Through compiling observational research, personal experiences, and conversations with dozens of innovators from around the world, obstacles for investing were pinpointed and identified, including: (i) innovators struggling to connect with the right expert; (ii) finding experts with knowledge tailored to the needs of the innovator; (iii) raising capital for innovators to continue innovating; (iv) corporations with investment funds lacking information and a model to find the right idea; and (v) no appropriate platform to connect innovators, experts, and investors.

Ideas ready for investing may come from many sources such as emerging economies like India, China and Brazil, large institutional societies, or even the garage of an ambitious inventor. Regardless of source, the idea may lack the resources and capabilities crucial to successfully grow and diffuse. This may be the case even some of the most potentially innovative solutions. For example, an investor in Brazil may consider the idea of an innovator in China to be a high quality investment based on the opinion of an Indian expert, but currently none of these parties may be aware of the others.

Thus, there is a long-felt but unmet need in the innovation and investment fields, namely connecting innovators, investors, and experts. And there is room for novelty and improvement in this, as in any, art.

### SUMMARY OF THE DISCLOSURE

Generally disclosed is an online, computerized, expert review system for ideas stored on a collaborative platform. The disclosure relates to a system and method of providing an unbiased, expert analysis to ideas to determine if they are ready for investment. Investors are able to initiate the expert review system for a particular idea where ranked experts provide feedback on relevant criteria such as impact, feasibility, sustainability, and innovativeness. Thus, the matched expert system stimulates and provides for assurance for investing in the idea after receiving an unbiased expert review from experts matched to the particular idea.

Disclosed is a tailored expert referral system for investors to evaluate ideas of interest over a collaborative network. Also disclosed is the ability for innovators to display their ideas to investors, and investors are able to have an idea evaluated by one or more experts from a repository of qualified and pre-ranked experts. Investors are also able to choose the precise criteria related to a particular area of innovation and rank those criteria according to the importance and deemed necessary to make a sound investment decision. This disclosure provides innovators with another manner of advertising and promoting their ideas, and investors, assurance in their investment through an unbiased, customized expert evaluation process.

Disclosed is a method for evaluating an idea with expert review, the method comprising collecting and receiving ideas from users. The ideas are stored within a secure server accessible through a network. These ideas are then displayed to investors who have pre-registered and self-certified as investors. An investor then initiates evaluation of an idea by choosing a particular idea in which they would like to have a financial and qualitative evaluation. Experts can be chosen from a database of profiles on the secure server where experts have pre-registered through the system. These experts are ranked through the expert impact score module and given an expert impact score upon initiation of review and selection by the investor of an idea to be evaluated by an expert panel. To create the expert panel, the investor chooses the experts without looking at the expert impact score or the experts are chosen depending on their rank and impact score.

The expert panel receives which evaluation criteria are to be evaluated and distribution to each expert as to which evaluation criteria individually they are to analyze. The Investor can assess criteria on numerous levels, such as: (i) which expert criteria to assign to which expert; (ii) on choosing the experts as a whole; (iii) on what weighting to apply to each of the evaluation criteria; or (iv) on the criteria for evaluation depending upon which criteria the investor wants to have more influence upon the evaluation process. If the investor chooses not to assign a weightage criteria, a default of equal weightage is applied. The idea is then evaluated according to the assigned criteria factors and provided a cumulative score to the idea. Experts then are able to recommend a monetary value range related to the cumulative evaluation score.

Disclosed is a method for evaluating an idea using expert review, the method comprising: (a) collecting and receiving ideas from users; (b) storing ideas received from users into a secure server accessible through a wide-area network; (c) displaying said ideas to interested investors;(d) initiating the evaluation of an idea for an investor; (e) choosing a selection of experts from an expert database to serve as an expert panel to evaluate the idea; assigning evaluation criteria to the expert panel, said criteria of evaluation being assigned to one or more experts; (f) assigning a percentage weight to each expert of the expert panel; (g) assigning a criteria weight to each criteria chosen for the expert panel; (h) evaluating the idea by the expert panel based on the chosen criteria and weights and providing a cumulative score to the idea; and recommending a monetary value range by the expert panel based on their evaluation.

Disclosed is a method wherein said users register themselves as investors, experts or innovators through the network.

Disclosed is a method wherein self-registered experts are evaluated to provide expert impact scores and stored within an expert database.

Disclosed is a method wherein factors for expert impact score evaluation are comprised of time dedication, conflict of interest, experience, or prior success and failure.

Disclosed is a method wherein expert impact factors are evaluated and assigned a numerical expert impact score.

Disclosed is a method wherein experts are ranked relative to their expert impact scores.

Disclosed is a method wherein the experts are chosen for the expert panel from the expert repository by the investor or automatically recommended based on expert impact score.

Disclosed is a method wherein the experts are assigned a percentage weight by the investor or default assignment.

Disclosed is a method wherein the default assignment percentage weight is 100%.

Disclosed is a method wherein the criteria of evaluation comprises at least one of impact, innovativeness, feasibility, or sustainability.

Disclosed is a method further comprising determining criteria weights to be assigned to each of the criteria of evaluation.

Disclosed is a method wherein the criteria weights are assigned by either one of the investor or default criteria weight assignment.

Disclosed is a method wherein the default assignment for criteria weight assignment is 100%.

Disclosed is a method further comprising the expert committee recommending a monetary value range of the idea based on the cumulative score of the idea.

Disclosed is a method further comprising the expert committee recommending an equity share to be offered to the investor based on the suggested monetary value range and an investment amount from the investor.

Disclosed is a method further comprising commencing contract negotiation between the investor and the entrepreneur, if the idea is approved by the Investor.

Further disclosed is a system for evaluating an idea using expert review, the system comprising: (a) a network interface for connecting users through a network, wherein users are able to register as Innovators, Experts and Investors; (b) a server for storing the self-registered profile of a user and making it viewable by other users of the system; (c) at least one user computer connected to the network for submitting an idea for evaluation from an Innovator; (d) the server further comprising initiation of expert evaluation of an Innovator's idea based on receiving instructions from an Investor; (e) the server further comprising instructions on selecting an expert panel from the ranked experts of the expert repository and assigning the expert panel for evaluating the idea; (f) the server further comprising instructions adapted to assign one or more criteria of evaluation to the experts in the expert panel, said criteria being chosen by the Investor; (g) the server further comprising communication instructions to receive from the expert panel a score to the idea on each of the assigned criteria of evaluation; (h) the server further comprising instructions adapted to apply expert weights assigned to each expert by the Investor to the scores given by each of the experts on each of the assigned criteria of evaluation; (i) the server further comprising instructions adapted to calculate criteria scores to the idea on each of the criteria of evaluation based on the expert weights and the scores provided by the experts on the criteria of evaluation; and (l) the server further comprising instructions adapted to calculate a cumulative score of the idea based on the criteria scores.

Disclosed is a system wherein the criteria of evaluation comprises at least one of impact, innovativeness, feasibility or sustainability.

Disclosed is a system wherein the server further comprises instructions to receive the chosen criteria of evaluation from the Investor.

Disclosed is a system wherein the server further comprises instructions adapted to receive Investor-assigned weighted percentages of each criteria and each expert and assigns these percentages to each of the criteria of evaluation and each expert.

Disclosed is a system wherein the expert weights and the criteria weights are determined by at least one of Investor choice or by default.

Disclosed is a system wherein the default percentage value applied to the criteria and expert weights is 100%.

Disclosed is a system wherein the server further comprises instructions to calculate and provide expert impact scores based on time dedication, conflict of interest, experience, or prior success and failure.

Disclosed is a system wherein the expert impact score factors are evaluated and assigned a numerical score known as the expert impact score.

Disclosed is a system wherein the experts are ranked in numeric descending order according to the expert impact score of the expert.

Disclosed is a system wherein the server further comprises instructions adapted to recommend experts to the investor from the expert repository for evaluating the idea.

Disclosed is a system wherein the server further comprises instructions to display expert impact scores in order for an Investor to select the expert panel from the expert repository.

Disclosed is a system wherein the server further comprises instructions to receive cumulative scored from Experts after evaluating the idea.

Disclosed is a system wherein the server further comprises instructions adapted to calculate the cumulative score of the idea using the expert weight percentages and the criteria weight percentages.

Disclosed is a system wherein the server further comprises the ability to display the final calculated score to the Investor.

Disclosed is a system wherein the server further comprises instructions to receive from the expert panel a recommended monetary value range of the idea based on the cumulative score of the idea.

Disclosed is a system wherein the server comprises instructions to receive from the expert panel a recommended equity share of the innovation to be offered to the investor based on the monetary value range of the idea and an investment amount from the investor.

Disclosed is a system wherein the server further comprises instructions adapted to commence contract negotiation between the investor and the entrepreneur, if the idea is selected by the investor.

### BRIEF DESCRIPTION OF THE DRAWINGS

FIG. 1 is a schematic representation of a computerized system for the secure transmission of data.

FIG. 2 is a schematic representation of an expert evaluation system.

FIG. 3 is a schematic representation of the architecture of a secure server.

FIG. 4A is a flow chart illustrating an expert referral system initiated by an investor.

FIG. 4B is a flow chart illustrating an exemplary method for selection of experts to assess an innovator's idea, referred to herein as an “Expert Impact Score Module.”

FIG. 5A is a schematic representation of an exemplary method for evaluating an idea and presenting the value of the idea to an investor.

FIG. 5B is is a schematic representation of an exemplary list of criteria selected experts apply to the innovator's idea.

### DETAILED DESCRIPTION OF THE DISCLOSURE

The present invention generally relates to an online collaborative system for displaying ideas for investing and providing an expert referral system for an investor. Specifically, this invention relates to an expert referral system where experts can be chosen based upon ranked recommendation for evaluation of ideas for investor assurance.

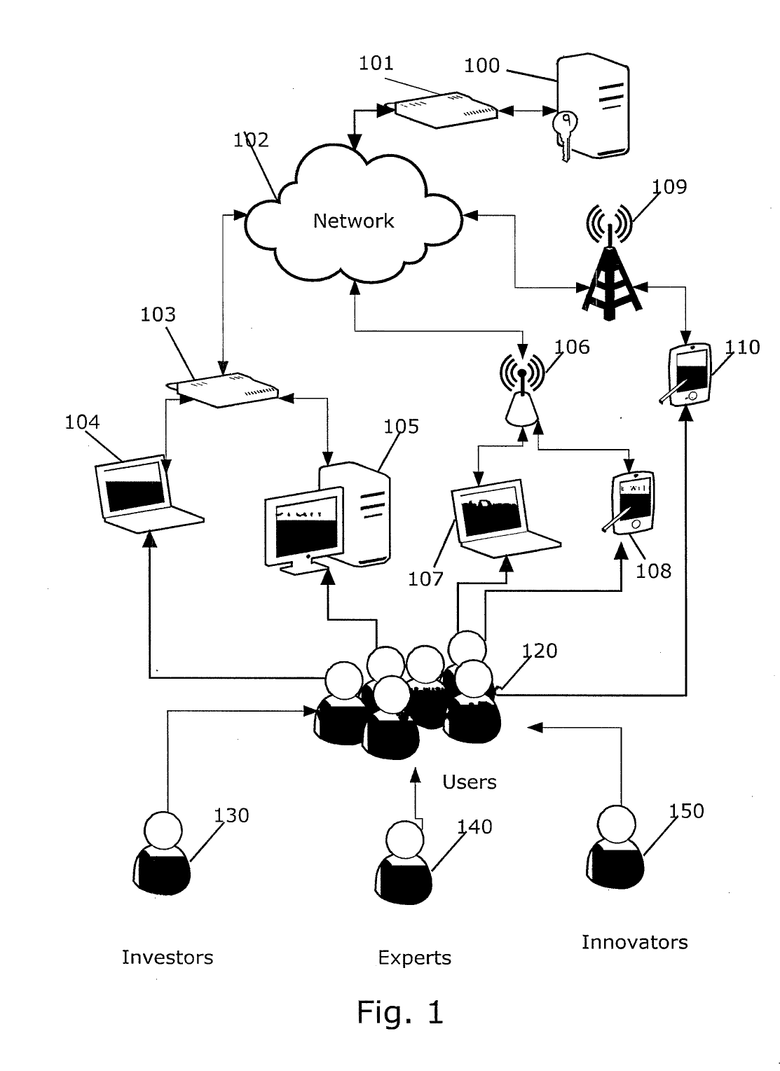

Referring to the foregoing drawings in detail wherein like parts are designated by like reference numerals throughout, FIGS. 1-5B illustrate an embodiment of a system and method for providing an expert referral system on a collaborative network according to the present invention.

Although the present invention will be described with reference to the example embodiments, the foregoing description of the preferred embodiments is not to be deemed limiting of the invention, which is defined by the appended claims. A person of ordinary skill in the art, relying on the foregoing disclosure, can appreciate and practice variants of the embodiments described without departing from the scope of the invention claimed. A feature or dependent claim limitation described in connection with one embodiment or independent claim may be adapted for use with another embodiment or independent claim, without departing from the scope of the invention.

Those in the art will further understand that the steps set out in the discussion above may be combined or altered in specific adaptations of the disclosure. The illustrated steps are set out to explain the embodiment shown, and it should be anticipated that ongoing technological development may change the manner in which particular functions are performed. These depictions do not limit the scope of the claimed invention, which is determined solely by reference to the appended claims.

According to an embodiment of the present invention, the system and method are accomplished through the use of one or more computing devices connected to a secure server over a network. One of ordinary skill in the art would appreciate that a computing device appropriate for use with embodiments of the present application may generally be comprised of one or more of a Central Processing Unit (CPU), Random Access Memory (RAM), and a storage device (e.g. hard disk drive, solid state drive, flash memory). Examples of computing devices usable with embodiments of the present invention include, but are not limited to, personal computers, laptops, smart phones, mobile computing devices, hand-held devices, tablets, and servers. One of ordinary skill in the art would appreciate that any number of computing devices could be used individually or in conjunction. It can also be appreciated that embodiments of the present invention are contemplated for use with any computing device capable of connecting to a network.

The present invention is further accomplished through the use of an exemplary secure server 100 wherein the server may include, but is not limited to, a file server, a domain name server, a proxy server, a web server, a computer workstation, or any other device operable to dynamically adjust the access restrictions imposed on the requested data by operation of the present invention. Further, the secure server 100 may run any appropriate operating system, including but not limited to MS-DOS®, MAC-OS®, UNIX®, and any other appropriate operating systems that may be developed hereafter within contemplation of use of a server.

In an exemplary embodiment according to the present invention, data may be provided to the system, stored by the system, and provided by the system to users of the system across local area networks (LANs), e.g. office networks, home networks, or wide-area networks (WANs, e.g. the Internet). In accordance with the previous embodiment, the system may be comprised of numerous servers operatively communicating across one or more LANs and/or WANs and connecting users to the system. One of ordinary skill in the art would appreciate that there are numerous arrangements in which the present invention could be configured to connect to a network and server through computing devices and embodiments of the present invention are contemplated for use with any configuration.

Disclosed at FIG. 1 is a schematic of a computerized system for the secure transmission of data. Secure server 100 exchanges information through network 102 via connections to one or more routers 101. The connection between secure server 100 and router 101 is exemplary of one route of data transmission from secure server 100 to network 102, and is not limited to a single router. One skilled in the art can appreciate that there are several ways that secure server 100 can connect to network 102. The connection between secure server 100 and router 101 can be wireless. The connection between router 101 and network 102 can be wireless or any connection which facilitates network communication for the purpose of storing and sharing information.

Users 120 of the network 102 are characterized as investors 130, experts 140, or innovators 150. Users 120 connect to network 102 in a variety of ways. Users 120 can connect to network 102, via router 103, with laptop 104 or personal computer 105. Users 120 can connect to network 102, via the wireless router 106, with personal computer 107 or hand-held device 108. Users 120 can also use hand-held device 110 to connect to mobile telecommunications device 109. The connection between network 102 and router 103 is wired, whereas the connection between network 102 and wireless router 106, and the connection between network 102 and mobile telecommunications device 109, is wireless.

Users 120 of the system may register on secure server 100 by providing identifying information, including but not limited to, name or company name, location, contact information, area of interest, area of expertise, qualifications, background, years of experience, prior project successes and amount of time willing to be dedicated to projects. These data are stored on secure server 100. Identifying information is used to identify the individual user upon subsequent access, secure the individual user's login, identify the individual user, identify the individual user's status upon later registration as an innovator, expert, or investor, or process financial transactions on behalf of the individual user.

Users 120 register and self-identify as investors 130, experts 140, or innovators 150. The purpose of self-identification is to identify the individual user's purpose of accessing secure server 100. In other words, the individual user self-identifies the function that the individual user wishes to perform.

Users 120 may register and self-identify as Investors 130. Investors 130 are individuals or entities potentially interested in investing in ideas presented on the platform. The individuals can be wealthy individuals, or angel investors. The entities can be groups of individual investors, companies associated with angel investors, venture capitalists, or hedge funds. Some individuals or entities can be classified as “accredited investors” or “institutional investors,” under the U.S. securities laws. Non-limiting examples of entities include technology incubation centers of universities, entities looking for suitable entries for an innovation challenge, or any entity looking to invest in an innovation opportunity. Investors 130 have access to a repository of ideas stored on secure server 100. Investors 130 can sort through ideas within the repository of ideas to choose one or more ideas for further investigation, and upon selection of an idea or ideas for evaluation can initiate the expert review process.

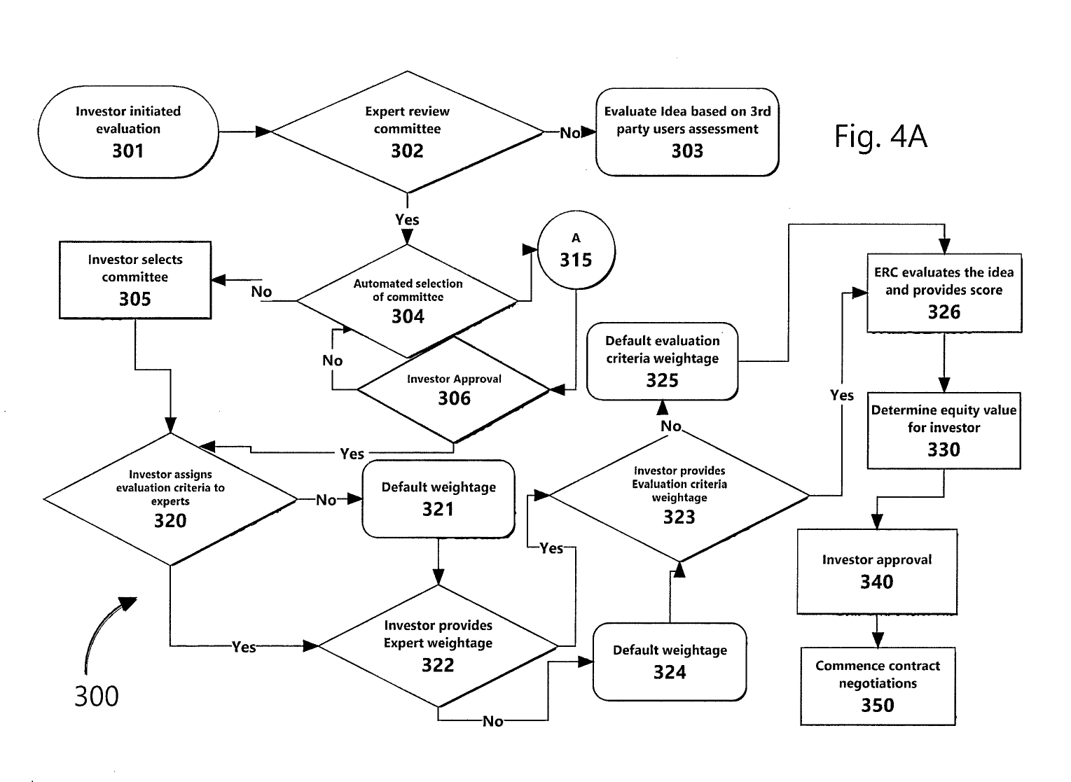

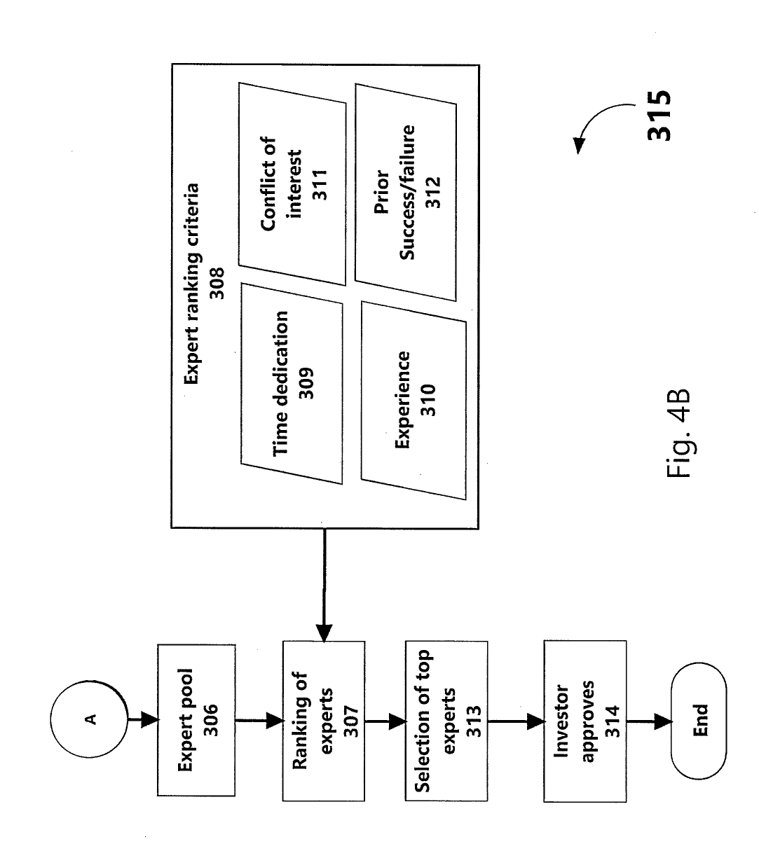

Users 120 may register and self-identify as Experts 140. Experts 140 are individuals that have one or more skill, capability, attribute, or ability relevant to the assessment of ideas. Non-limiting examples of experts that may register are academic professors, research scientists, consultants, analysts, and volunteer experts. Experts self-register by providing data requested by the expert database, including but not limited to background and education, fields of expertise, years of experience in the field, prior project successes, potential time dedication to evaluation of ideas, conflicts of interest, qualifications and unique skills Upon self-registration as and data entry for an Expert, the information is automatically evaluated by the Expert Impact Score Module 315 of FIG. 4B. This data is entered into the Expert Database 144. Once registered as Experts and evaluated through the Expert Impact Score Module 315, they are able be matched with an idea and requested to serve on an expert panel 147 for the evaluation of an idea for an Investor.

Users 150 may register and self-identify as Innovators 150. Innovators 150 post and articulate ideas in which they are seeking Investors 130. The Innovators 150 may provide information on the secure server 100 authorizing the level of access to their posted ideas. For example, in one embodiment, the Innovators 150 may authorize Investors 130 in a specific domain, having a certain background of interest, or having a minimum investment capital to view their ideas. These ideas will be stored on the secure server 100 and accessible to other users 120 through the secure server 100. These ideas are able to be viewed by all other users such that investors 130 may contemplate the idea for investment and experts 140 may contemplate the idea for review.

Users who choose to self-identify as Investor, Expert, or Innovator are not relegated to these categories. Once the action taken has completed in one of these categories—such as an expert has reviewed an idea on an expert panel, or an Investor has initiated and received an expert evaluation—that user may then become a non-specified third party user and engage in other program activities, or choose another category to self-identify and initiate another process of the system.

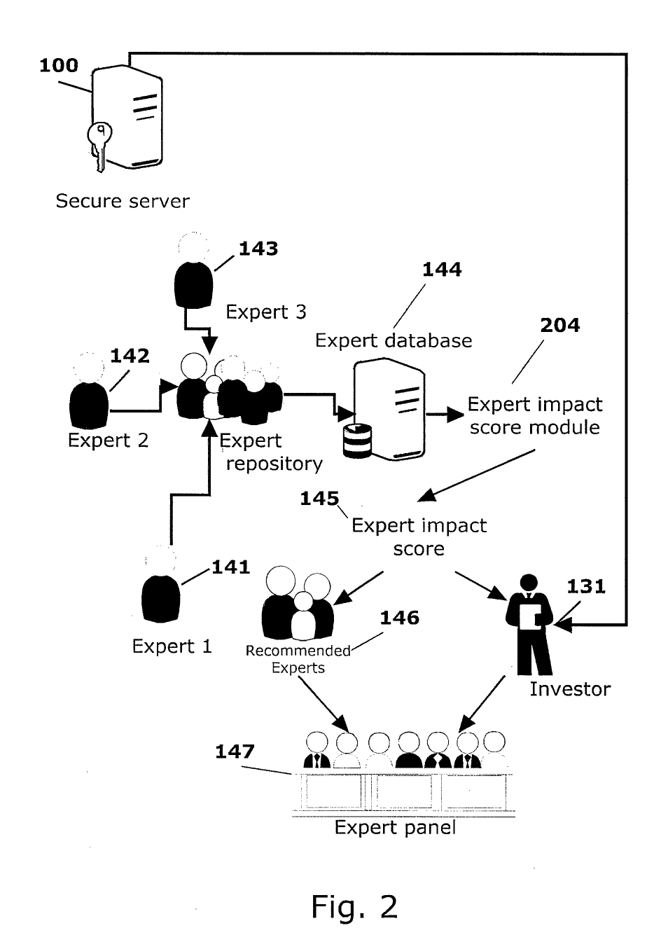

Disclosed in FIG. 2 is an expert evaluation system. Users 120, such as Experts 1, 2, and 3 (141, 142, and 143, respectively), and who have registered and self-identified as Experts 140 enter information qualifying them as Experts 140. Individuals registering as experts enter information to form a profile, enter their information, which is then stored in a data-accessible Expert database 144. The information stored is then converted to an expert impact score 145 using the expert impact score module 315 as described in FIG. 4B for each expert registered. These expert impact scores 145 are then displayed to Investors who have chosen to initiate an evaluation for choosing their experts. Alternatively, the top experts recommended through the system are automatically chosen for the investor and displayed to investor as a recommended panel 146. If the Investor approves this recommended panel or chooses their own experts, this panel then comprises the expert panel 147 for evaluation.

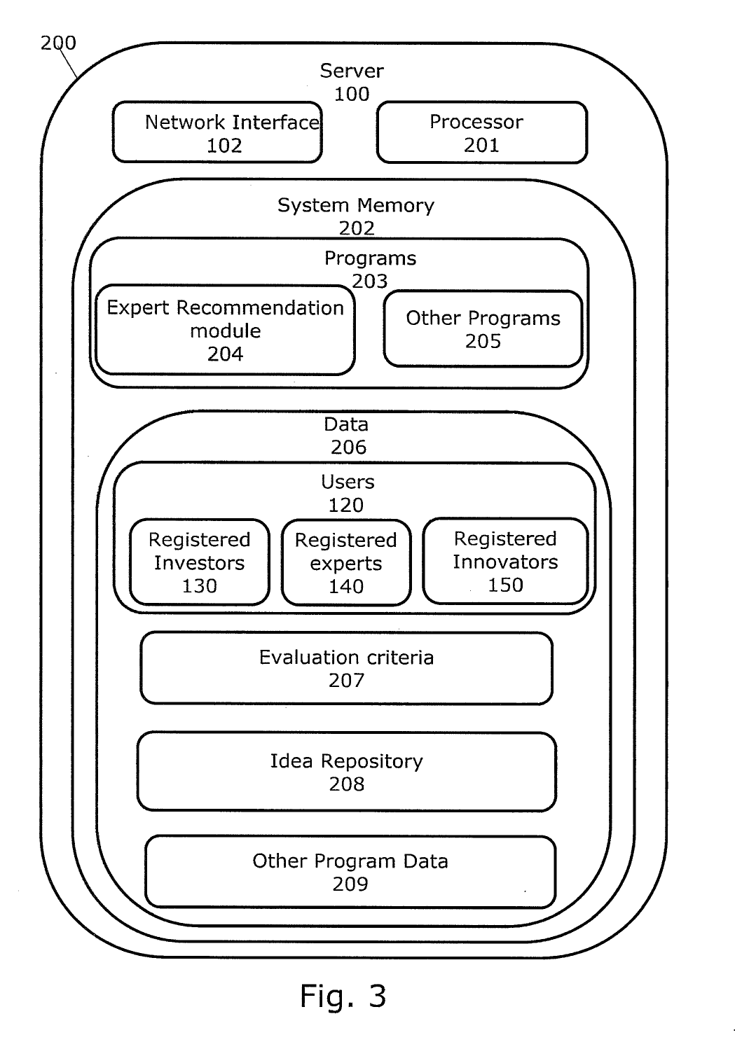

Disclosed at FIG. 3 is the architecture of a device 200. Device 200 is secure server 100. Secure server 100 has network interface 102, processor 201, and system memory 202. System memory 202 is divided into Programs 203 and Data 206. Programs 203 include Expert Impact Score Module 204, disclosed in FIG. 2, FIG. 4B, and herein. Programs 203 also include Other Programs 205. Data 206 includes a registry of users 120. The information of users 120 includes any users who have registered with the system but have not yet self-identified as an Investor 130, Expert 140, or Innovator 150. The information for users 120 further includes information of users who have registered and self-identified as Registered Investors 130, Registered Experts 140, or Registered Innovators 150. Data 206 include Evaluation Criteria 207 that Experts 140 and Investors 130 will use to evaluate the ideas presented by Innovators 150. Data 206 also include an Idea Repository 208 where the ideas submitted by Innovators 150 are stored. Data 206 additionally includes any other program data 209.

Disclosed at FIG. 4A is an exemplary illustration of expert referral. An Investor initiates the evaluation 301 by selecting an idea from the Idea Repository. The investor then has the option to choose the expert review committee 302 and start the process of expert selection, or to opt out of the expert review committee option 303, then pick the idea and connect immediately with the innovator. When the Investor chooses to initiate the expert review committee process, the Investor may then opt for the automated selection of a committee of experts 304. This then prompts the Expert Impact Score Module 315 continued on and illustrated in FIG. 4B and disclosed herein. The Investor has the option to approve the choice the Expert Impact Score Module recommends 313. If the Investor chooses to personally select the committee 305, the Investor is then prompted whether or not to assign specific evaluation criteria to specific experts of the panel 320. The default is 100% or no extra weightage 321. The Investor can choose to assign weighting to each expert as a whole 322. The default is 100% or no extra weightage 324. The investor can then choose what weightage to give each of the evaluation criteria. The default is 100% or no extra weightage 325. The Investor has this option to assign criteria as there may be situations in which they would like those experts with more expertise in certain areas to evaluate one criteria, whereas another expert may be assigned a different criteria for evaluation. For example, one expert may be a financial expert that has experience valuating ideas in the innovation sector, but this financial expert may not have knowledge or expertise on the sustainability of inventions. The investor is then able to differentiate between experts and which criteria they should evaluate. This has the potential to eliminate the amount of bias to any particular expert, and especially avoids giving undue credence to those who may not have expertise in all fields of criteria represented. The Investor is given the option to assign any number of criteria to each expert, including impact, feasibility, sustainability, and innovativeness.

If the Investor opts out of choosing specific weighting for specific experts, the default option is chosen 321 wherein each expert is assigned all four criteria, and each criteria for evaluation lends equal percentage of weight to the overall score. The Investor is then able to decide whether or not to provide weightage to each Expert 322. In this sense, the Investor again has the ability to customize the evaluation of the ideas so that there is a more defined review process tailored to what information the Investor is looking to pinpoint before deciding to invest. The investor may assign additional percentage of weight to any expert in the chosen expert panel such that the score of that particular expert would have that percentage applied to it 323. Thus, the criteria and expert would have an applied increased percentage to produce a heightened amount of influence to that particular expert.

If the Investor opts out of applying additional expert weightage, the default weightage of equal proportion of influence from each expert is applied 324.

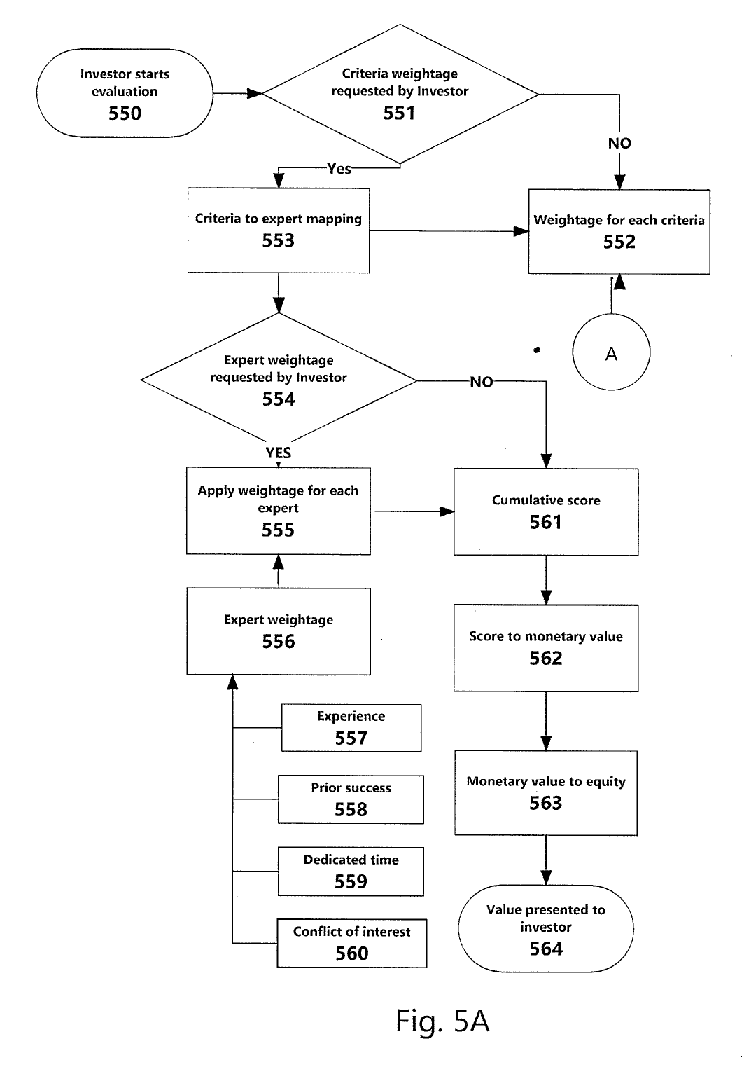

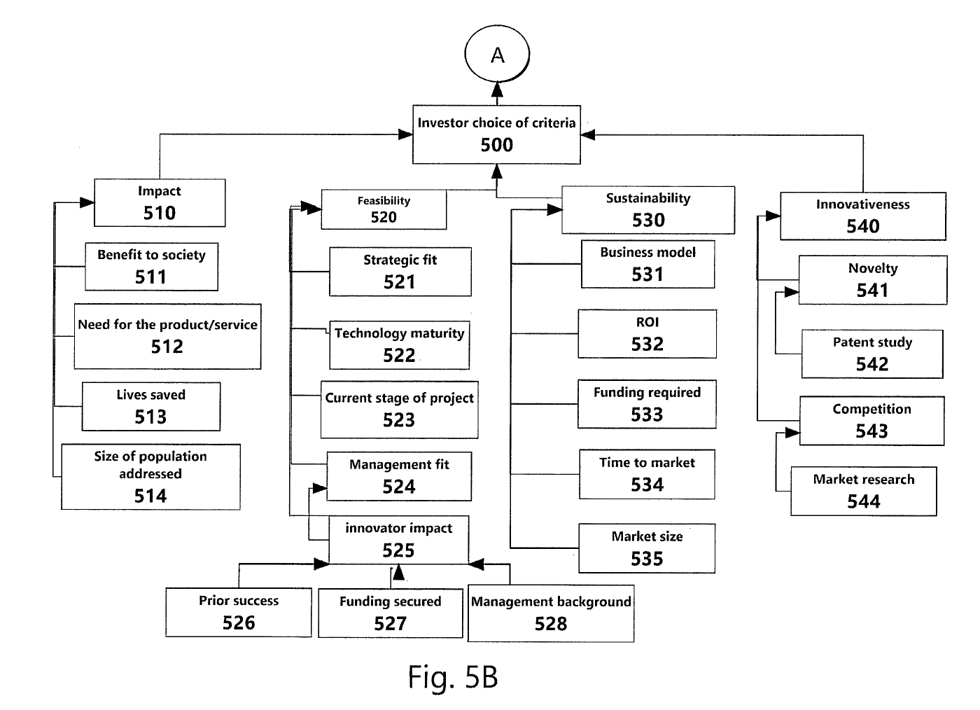

Once the evaluation criteria, experts, expert weightage, and criteria weightage are chosen and assigned, the experts may then evaluate the idea based on the criteria chosen and assigned to each. The criteria and evaluation factors are illustrated in FIGS. 5A and B and are disclosed herein. Once the evaluation is complete, the Expert panel will provide a cumulative score out of 100 to the investor 326. The Investor may use this score as an overall evaluation to consider the investment opportunity, look at their potential for engagement and compare the idea reviewed to other ideas. If requested, the Expert panel may then recommend an equity value related to the amount of funds being requested by the Innovator 330. The investment can be approved by the investor 340, contract negotiations with the innovator may begin 350.

Disclosed at FIG. 4B is an exemplary method for selection of experts to assess an innovator's idea. The profiles of experts are accumulated into a pool 306. The experts have self-identified as experts, and their relative expertise has not been determined. To determine the experts' relative expertise, the experts are ranked 307 by being subject to expert ranking criteria 308. The criteria are: (i) the amount of time that an individual expert can dedicate to assessing any innovator's idea 309; (ii) the individual expert's experience 310; (iii) the absence of any conflicts of interest among the individual expert, the innovator, and the investor 311; and (iv) whether the individual expert has experienced success or failure in previous ventures 312. Accumulating and evaluating these criteria for all of the experts' profile allows the ranking of expert profiles and hence the ranking of experts 307. After the experts have been ranked, the top-ranking experts are selected 313 and the selection is forwarded to the investor for approval 314. Once the selected experts are approved, these experts assess the innovator's idea.

Disclosed at FIG. 5B is an exemplary list of criteria selected experts apply to the innovator's idea 500. These criteria are classified as impact 510, feasibility 520, sustainability 530, and innovativeness 540. These criteria are subclassified. Impact 510 is subclassified into (i) benefit to society 511; (ii) the need for the product or service 512; (iii) the projected number of lives saved 513; and (iv) the size of the population addressed 514. Feasibility 520 is subclassified into (i) strategic fit 521; (ii) technological maturity 522; (iii) the current stage of the project 523; (iv) the management fit 524; and (v) the innovator fit 525. The innovator fit 525 is further subclassified into: (a) the prior success of the innovator 526; (b) the funding secured by the innovator 527; and (c) the management background of the innovator. Sustainability 530 is subclassified into: (i) the strength of the business model 531; (ii) the projected return on investment (ROI) 532; (iii) the funding required or requested 533; (iv) the projected time to market the product or services 534; and (v) the projected market size 535. Innovativeness 540 is subclassified into: (i) novelty 541; and (ii) an assessment of the product or service's likely competition 543. One criterion for assessing novelty 541 is whether a patentability study has been performed 542. And, one criterion for assessing the product or service's likely competition 543 is whether any market research has been performed 544.

Disclosed at FIG. 5A is an exemplary method for evaluating an idea and presenting the value of the idea to an investor. An investor commencing an evaluation 550 is given the option 320 of adding a weightage to the criteria 553 used by the experts to assess the innovator's idea. By way of a non-limiting example, an investor more interested in the benefit to society 511 than the return on investment 532 of the innovator's idea may apply a greater weightage to the benefit to society 511 than the return on investment 532. The investor may even apply a weightage of zero 323, i.e., 100% or no extra weightage at all, to some criteria 552. Similarly, the investor is given the option 322 of adding a weightage 555 to the expert's ranking 556. The investor may do so by adding a weightage to the expert's experience rank 557, prior success 558, time available to dedicate to the innovator's idea 559, and the absence of any conflict of interest 560. The investor may even apply a weightage of zero, i.e., 100% or no extra weightage at all, to some ranking data. After adding any weighting to the criteria used by experts and adding any weighting to the ranking of individual experts, the score for the innovator's idea is cumulated 561. The cumulated score 561 is converted to a monetary value 562, which is then converted to equity 563. This indicia of value is then presented to the investor 564.

Modifications to the device herein represented and described, and alternative embodiments to the invention, will be apparent to one skilled in the art. It can be appreciated by one skilled in the art that changes can be made to the exemplary embodiments shown and detailed above without departing from the inventive scope and spirit of the invention described herein.

What is claimed is:

1. A method for evaluating an idea using expert review, the method comprising:
collecting and receiving ideas from users;
storing ideas received from users into a secure server accessible through a wide-area network;
displaying said ideas to interested investors;
initiating the evaluation of an idea for an investor;
choosing a selection of experts from an expert database to serve as an expert panel to evaluate the idea; assigning evaluation criteria to the expert panel, said criteria of evaluation being assigned to one or more experts;
assigning a percentage weight to each expert of the expert panel;
assigning a criteria weight to each criteria chosen for the expert panel;
evaluating the idea by the expert panel based on the chosen criteria and weights and providing a cumulative score to the idea; and
recommending a monetary value range by the expert panel based on their evaluation.

2. The method of claim 1, wherein said users register themselves as investors, experts or innovators through the network.

3. The method of claim 1, wherein self-registered experts are evaluated to provide expert impact scores and stored within an expert database.

4. The method of claim 3, wherein factors for expert impact score evaluation are comprised of time dedication, conflict of interest, experience, or prior success and failure.

5. The method of claim 4, wherein expert impact factors are evaluated and assigned a numerical expert impact score.

6. The method of claim 5, wherein experts are ranked relative to their expert impact scores.

7. The method of claim 1, wherein the experts are chosen for the expert panel from the expert repository by the investor or automatically recommended by based on expert impact score.

8. The method of claim 1, wherein the experts are assigned a percentage weight by the investor or default assignment.

9. The method of claim 8, wherein the default assignment percentage weight is 100%.

10. The method of claim 1, wherein the criteria of evaluation comprises at least one of impact, innovativeness, feasibility, or sustainability.

11. The method of claim 1, further comprising determining criteria weights to be assigned to each of the criteria of evaluation.

12. The method of claim 1, wherein the criteria weights are assigned by either one of the investor or default criteria weight assignment.

13. The method of claim 12, wherein the default assignment for criteria weight assignment is 100%.

14. The method of claim 1, further comprising the expert committee recommending a monetary value range of the idea based on the cumulative score of the idea.

15. The method of claim 4, further comprising the expert committee recommending an equity share to be offered to the investor based on the suggested monetary value range of claim 4 and an investment amount from the investor.

16. The method of claim 1, further comprising commencing contract negotiation between the investor and the entrepreneur, if the idea is approved by the Investor.

17. A system for evaluating an idea using expert review, the system comprising:
a network interface for connecting users through a network, wherein users are able to register as Innovators, Experts and Investors;
a server for storing the self-registered profile of a user and making it viewable by other users of the system;
at least one user computer connected to the network for submitting an idea for evaluation from an Innovator;
the server further comprising initiation of expert evaluation of an Innovator's idea based on receiving instructions from an Investor;
the server further comprising instructions on selecting an expert panel from the ranked experts of the expert repository and assigning the expert panel for evaluating the idea;
the server further comprising instructions adapted to assign one or more criteria of evaluation to the experts in the expert panel, said criteria being chosen by the Investor;
the server further comprising communication instructions to receive from the expert panel a score to the idea on each of the assigned criteria of evaluation;
the server further comprising instructions adapted to apply expert weights assigned to each expert by the Investor to the scores given by each of the experts on each of the assigned criteria of evaluation;
the server further comprising instructions adapted to calculate criteria scores to the idea on each of the criteria of evaluation based on the expert weights and the scores provided by the experts on the criteria of evaluation; and
the server further comprising instructions adapted to calculate a cumulative score of the idea based on the criteria scores.

18. The system of claim 17, wherein the criteria of evaluation comprises at least one of impact, innovativeness, feasibility or sustainability.

19. The system of claim 18, wherein the server further comprises instructions to receive the chosen criteria of evaluation from the Investor.

20. The system of claim 17, wherein the server further comprises instructions adapted to receive Investor-assigned weighted percentages of each criteria and each expert and assigns these percentages to each of the criteria of evaluation and each expert.

21. The system of claim 20, wherein the expert weights and the criteria weights are determined by at least one of Investor choice or by default.

22. The system of claim 21, wherein the default percentage value applied to the criteria and expert weights is 100%.

23. The system of claim 17, wherein the server further comprises instructions to calculate and provide expert impact scores based on time dedication, conflict of interest, experience, or prior success and failure.

24. The system of claim 23, wherein the expert impact score factors are evaluated and assigned a numerical score known as the expert impact score.

25. The system of claim 24, wherein the experts are ranked in numeric descending order according to the expert impact score of the expert.

26. The system of claim 17, wherein the server further comprises instructions adapted to recommend experts to the investor from the expert repository for evaluating the idea.

27. The system of claim 17, wherein the server further comprises instructions to display expert impact scores in order for an Investor to select the expert panel from the expert repository.

28. The system of claim 17, wherein the server further comprises instructions to receive cumulative scored from Experts after evaluating the idea.

29. The system of claim 17, wherein the server further comprises instructions adapted to calculate the cumulative score of the idea using the expert weight percentages and the criteria weight percentages.

30. The system of claim 17, wherein the server further comprises the ability to display the final calculated score to the Investor.

31. The system of claim 17, wherein the server further comprises instructions to receive from the expert panel a recommended monetary value range of the idea based on the cumulative score of the idea.

32. The system of claim 28, wherein the server comprises instructions to receive from the expert panel a recommended equity share of the innovation to be offered to the investor based on the monetary value range of the idea and an investment amount from the investor.

33. The system of claim 17, wherein the server further comprises instructions adapted to commence contract negotiation between the investor and the entrepreneur, if the idea is selected by the investor.
